(19) United States
(12) Patent Application Publication
(10) Pub. No.: US 2022/0004134 A1
(43) Pub. Date: Jan. 6, 2022

(54) IMAGE FORMING APPARATUS

(71) Applicant: KYOCERA Document Solutions Inc., Osaka (JP)

(72) Inventor: Keisuke Mizuguchi, Osaka (JP)

(21) Appl. No.: 17/367,001

(22) Filed: Jul. 2, 2021

(30) Foreign Application Priority Data
Jul. 6, 2020 (JP) 2020-116192

(51) Int. Cl. G03G 15/00; B65H 7/20; B65H 5/02

(52) U.S. Cl. CPC G03G 15/5054; B65H 7/20; B65H 2553/822; B65H 5/025; G03G 15/6511

(57) ABSTRACT

A feeding portion includes a pickup member and a feeding member. A first sheet sensor that is arranged on an upstream side in a sheet conveyance direction with respect to a conveying member, detects a sheet conveyed along a conveyance path. A second sheet sensor detects the sheet at a position between the pickup member and the feeding member. A control portion causes the feeding portion to start feeding of a subsequent sheet when the subsequent sheet is detected by the second sheet sensor at a first timing after detection of a preceding sheet by the first sheet sensor. Furthermore, the control portion causes the feeding portion to start feeding of the subsequent sheet at a second timing later than the first timing, when the subsequent sheet is detected by the second sheet sensor at the first timing.

### INCORPORATION BY REFERENCE

This application is based upon and claims the benefit of priority from the corresponding Japanese Patent Application No. 2020-116192 filed on Jul. 6, 2020, the entire contents of which are incorporated herein by reference.

The present disclosure relates to an image forming apparatus adapted to control a timing of feeding a sheet to a conveyance path.

### BACKGROUND

An image forming apparatus includes a sheet feeding device that feeds a topmost one of a plurality of sheets stacked on a sheet stacking portion such as a sheet cassette or a manual feed tray, to a conveyance path. The sheet feeding device includes a pickup roller and a feeding roller.

The image forming apparatus controls a timing of feeding the sheets one by one to the conveyance path by the sheet feeding device, when a continuous printing process is performed.

### SUMMARY

An image forming apparatus according to an aspect of the present disclosure includes a pickup member, a feeding member, a feeding portion, a conveying member, a first sheet sensor, at least one second sheet sensor, and a control portion. The pickup member feeds a topmost target sheet in a plurality of sheets from a sheet stacking portion, the plurality of sheets being stacked on the sheet stacking portion. The feeding member feeds a sheet fed by the pickup member to a conveyance path. The feeding portion includes the pickup member and the feeding member. The conveying member that is disposed in the conveyance path conveys the sheet fed by the feeding member. The first sheet sensor that is arranged on an upstream side in a sheet conveyance direction with respect to the conveying member in the conveyance path, detects a sheet conveyed along the conveyance path. The second sheet sensor detects the sheet at a position between the pickup member and the feeding member. The control portion controls the feeding portion when a continuous printing process is performed. The control portion causes the feeding portion to start feeding of a subsequent sheet when the subsequent sheet is detected by the at least one second sheet sensor at a first timing after detection of a preceding sheet by the first sheet sensor. Furthermore, the control portion causes the feeding portion to start feeding of the subsequent sheet at a second timing later than the first timing, when the subsequent sheet is detected by the second sheet sensor at the first timing.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to a first embodiment.

FIG. 2 is a block diagram of a configuration of a controller in the image forming apparatus according to the first embodiment.

FIG. 3 is a configuration diagram of a sheet feeding device in the image forming apparatus according to the first embodiment.

FIG. 4 is a diagram of the sheet feeding device in a state in which a target sheet is detected in the image forming apparatus according to the first embodiment.

FIG. 5 is a diagram of a relationship between a detection result of a front sheet sensor and a feeding time interval in the image forming apparatus according to the first embodiment.

FIG. 6 is a configuration diagram of the sheet feeding device in the image forming apparatus according to a second embodiment.

FIG. 7 is a diagram of detection results of the front sheet sensor and a rear sheet sensor and a feeding time interval in the image forming apparatus according to the second embodiment.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

### A First Embodiment: A Configuration of an Image Forming Apparatus 10

An image forming apparatus 10 according to a first embodiment performs a printing process for forming an image on sheets 9. The image forming apparatus 10 includes a sheet cassette 1, a main sheet feeding device 2, a sheet conveying device 3, a controller 8, an operating device 801, and a display 802.

The image forming apparatus 10 includes a print device 4. The sheet conveying device 3 and the print device 4 are accommodated in a body 100 that is a housing.

The sheet cassette 1 is mounted so as to be pulled out from the body 100. A lift plate 11 on which a plurality of sheets 9 to be conveyed to the print device 4 is placed, and an urging mechanism 12 configured to elastically urge the lift plate 11 upward, are provided inside the sheet cassette 1.

The main sheet feeding device 2 feeds a topmost one of the plurality of sheets 9 that is placed on the lift plate 11 to a conveyance path 30 in the body 100. The lift plate 11 is an example of a sheet stacking portion. The main sheet feeding device 2 is an example of a feeding portion.

The main sheet feeding device 2 includes a pickup roller 21, a feeding roller 22 and a separating roller 23. In the following description, the topmost one of the plurality of sheets 9 that is placed on the lift plate 11, is referred to as a target sheet 9a.

The pickup roller 21 feeds the target sheet 9a from the lift plate 11 to the feeding roller 22 by being rotated in contact with a surface of the target sheet 9a. Every time the pickup roller 21 feeds one of the sheets 9, the target sheet 9a on the lift plate 11 is replaced. The pickup roller 21 is an example of a pickup member.

The urging mechanism 12 urges the lift plate 11 upward, thereby the target sheet 9a on the lift plate 11 remains in contact with the pickup roller 21 even when the number of sheets 9 on the lift plate 11 is varied.

The feeding roller 22 is arranged in contact with the separating roller 23. The feeding roller 22 rotates in contact with the surface of the target sheet 9a that is fed from the pickup roller 21. This allows the feeding roller 22 to take over the conveyance of the target sheet 9a from the pickup roller 21 and to feed the target sheet 9a to the conveyance path 30. The feeding roller 22 is an example of a feeding member.

The separating roller 23 blocks subsequent sheets 9 following the topmost sheet when the pickup roller 21 feeds two or more sheets 9 from the lift plate 11 toward the feeding roller 22. The feeding roller 22 feeds the target sheet 9a to the conveyance path 30 while handling the target sheet 9a by an action of the separating roller 23.

The separating roller 23 avoids a double feeding in which the feeding roller 22 feeds the two or more sheets 9 to the conveyance path 30. The separating roller 23 is an example of a facing member that is placed in contact with the feeding roller 22.

In this embodiment, the image forming apparatus 10 further includes a manual feed tray 13 and an auxiliary sheet feeding device 20. The manual feed tray 13 functions as a cover capable of opening and closing an opening of the body 100. The manual feed tray 13 also functions as a sheet stacking portion on which the plurality of sheets 9 is stacked, in an opened state in which the opening is opened.

The auxiliary sheet feeding device 20 includes a pickup roller 201, a feeding roller 202 and a separating pad 203.

The pickup roller 201 rotates in contact with the surface of the topmost target sheet 9a in the plurality of sheets 9 placed on the manual feed tray 13. This allows the pickup roller 201 to feed the target sheet 9a from the manual feed tray 13 to the feeding roller 202.

The feeding roller 202 is arranged in contact with the separating pad 203. The feeding roller 202 rotates in contact with the surface of the target sheet 9a that is fed from the pickup roller 201. This allows the feeding roller 202 to take over the conveyance of the target sheet 9a from the pickup roller 201, and to feed the target sheet 9a to the conveyance path 30.

The separating pad 203 blocks the subsequent sheets 9 following the topmost sheet when the pickup roller 201 feeds the two or more sheets 9 from the manual feed tray 13 toward the feeding roller 202.

The separating pad 203 avoids the double feeding in which the feeding roller 202 feeds the two or more sheets 9 to the conveyance path 30. The separating pad 203 is an example of a facing member that is placed in contact with the feeding roller 202.

The sheet conveying device 3 includes a plurality of pairs of conveyance rollers 31 and a resist sheet sensor 32. Each pair of conveyance rollers 31 that is arranged in the conveyance path 30 nips each sheet 9 and rotates to convey each sheet 9 along the conveyance path 30.

The plurality of pairs of conveyance rollers 31 includes a pair of resist rollers 31a. The pair of resist rollers 31a conveys each sheet 9 to a transfer position P00 at a predetermined timing after pausing each sheet 9 conveyed from the corresponding pair of conveyance rollers 31 in a previous stage. The pair of resist rollers 31a is an example of a conveying member that conveys the target sheet 9a fed by the feeding roller 202 to a next stage. The pair of resist rollers 31a conveys each sheet 9 conveyed in the conveyance path 30 at a predetermined timing.

The resist sheet sensor 32 is arranged at a position closer to the pair of resist rollers 31a between the pair of resist roller 31a and the feeding roller in the conveyance path 30. That is, the resist sheet sensor 32 is arranged on an upstream side in a sheet conveying direction with respect to the pair of resist rollers 31a in the conveyance path 30. The resist sheet sensor 32 detects each sheet 9 conveyed in the conveyance path 30, at a position in the previous stage of the pair of resist rollers 31a. The resist sheet sensor 32 is an example of a first sheet sensor.

The pair of resist rollers 31a starts to work when a predetermined time has elapsed since the resist sheet sensor 32 detected each sheet 9 in a situation in which the pair of resist rollers 31a stops to work. This can adjust a timing at which each sheet 9 is conveyed to the transfer position P00.

The pickup rollers 21, 201, the feeding rollers 22, 202, and the plurality of pairs of conveyance rollers 31 are driven in rotation by a motor M1 and a transmission mechanism TM1 that transmits a driving force of the motor M1. The transmission mechanism TM1 includes a gear mechanism.

The pickup rollers 21, 201 and the feeding rollers 22, 202 can be stopped independently of other rotors by an action of a first clutch mechanism CL1 included in the transmission mechanism TM1. Similarly, the pair of resist rollers 31a can be also stopped independently of other rotors by the action of a second clutch mechanism CL2 included in the transmission mechanism TM1.

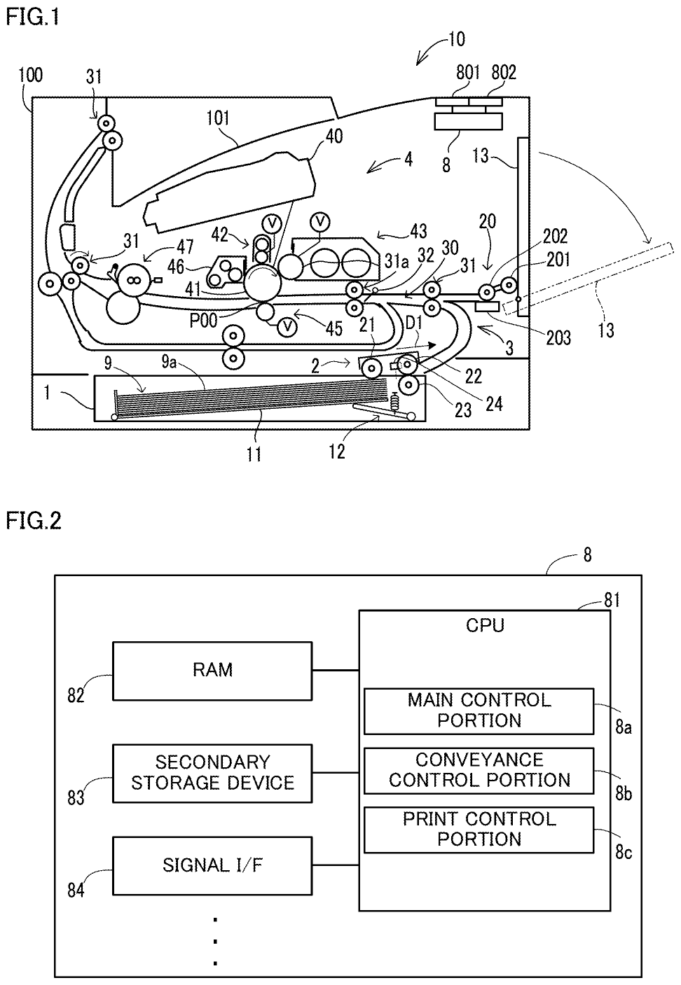

The print device 4 forms an image on a sheet 9 that has been fed from the lift plate 11 or the manual feed tray 13 by the main sheet feeding device 2 or the auxiliary sheet feeding device 20, and conveyed along the conveyance path 30. In the example shown in FIG. 1, the print device 4 forms the image on the sheet 9 with electrophotography.

For this purpose, the print device 4 includes an optical scanning unit 40, a photoconductor 41, a charger 42, a development device 43, a transfer device 45, a cleaning device 46, a fixing device 47, and the like.

The drum-like photoconductor 41 is rotated, and the charger 42 charges a surface of the photoconductor 41. The optical scanning unit 40 scans the surface of such charged photoconductor 41 with beam light. This allows an electrostatic latent image to be written on the surface of the photoconductor 41.

By an action of the charger 42 and the optical scanning unit 40, the electrostatic latent image based on image data to be printed is formed on the surface of the photoconductor 41.

The development device 43 develops the electrostatic latent image into a toner image by supplying a toner to the photoconductor 41 on which the electrostatic latent image is formed. By developing the electrostatic latent image, the photoconductor 41 is rotated while carrying the toner image. The photoconductor 41 is an example of an image carrier.

The transfer device 45 transfers the toner image on the photoconductor 41 to a sheet 9 at the transfer position P00 in the conveyance path 30. The fixing device 47 pressurizes while heating the toner image transferred to the sheet 9. This allows the fixing device 47 to fix the toner image to the sheet 9.

The print device 4 may be a device that forms an image on a sheet 9 by using other methods such as an inkjet method.

The operating device 801 is a device that accepts manual operations, the device including, for example, an operation button and a touch panel. The display 802 is a device that displays information, the device including, for example, a panel display such as a liquid crystal display unit.

As shown in FIG. 2, the controller 8 includes a CPU (Central Processing Unit) 81, and peripherals such as a RAM (Random Access Memory) 82, a secondary storage device 83, and a signal interface 84.

The CPU 81 is a processor that executes various data processing and controls by executing a computer program. The RAM 82 is a computer-readable volatile storage device. The RAM 82 primarily stores the computer program executed by the CPU 81 and data to be output and referenced in a process of various processes executed by the CPU 81.

The CPU 81 includes sets of processing modules realized by executing the computer program. The sets of processing modules include a main control portion 8a, a conveyance control portion 8b, and a print control portion 8c, etc.

The main control portion 8a executes a control to start various processes depending on an operation with respect to the operating device 801, and a control for the display 802.

The conveyance control portion 8b controls the main sheet feeding device 2, the auxiliary sheet feeding device 20, and the sheet conveying device 3. For example, the conveyance control portion 8b executes a continuous feeding control when a continuous printing process is performed.

In the continuous feeding control, the conveyance control portion 8b repeats a unit feeding control a plurality of times, the unit feeding control in which the pickup roller 21 and the feeding roller 22 are rotated for a predetermined time and then stopped. The conveyance control portion 8b executes the unit feeding control at a timing based on a time when the resist sheet sensor 32 detected a sheet 9.

The print control portion 8c causes the print device 4 to execute the printing process in synchronization with the conveyance of the sheet 9 by the sheet conveying device 3.

The secondary storage device 83 is a computer-readable non-volatile storage device. The secondary storage device 83 can store and update the computer program and various data. For example, either one or both of a flash memory and a hard disk drive are adopted as the secondary storage device 83.

The signal interface 84 converts signals outputted by various sensors such as a temperature sensor 58 into digital data, and transmits such converted digital data to the CPU 81. Furthermore, the signal interface 84 converts control commands outputted by the CPU 81 into control signals, and then transmits the control signals to a device to be controlled.

In the main sheet feeding device 2, the pickup roller 21 may feed two or more sheets 9 from the lift plate 11 toward the feeding roller 22. In this case, the separating roller 23 that is arranged so as to face the feeding roller 22 blocks the subsequent sheets 9 following the topmost sheet.

In the following description, when a second one following the topmost sheet on the lift plate 11 is fed to the feeding roller 22 side, it may be referred to as “follow-feeding”.

In the image forming apparatus 10, when the continuous printing process is performed, even in occurrence of the follow-feeding, the conveyance control portion 8b needs to control the timing of starting operations of the main sheet feeding device 2 such that intervals between the sheets 9 sequentially fed to the conveyance path 30 do not become too short.

On the other hand, in a case where the timing of starting the operations of the main sheet feeding device 2 is set on the assumption that the follow-feeding always occurs, when the follow-feeding does not occur, the intervals between the sheets 9 sequentially fed to the conveyance path 30 become large. In this case, the image forming apparatus 10 cannot maximize productivity of printed papers in the continuous printing process.

The image forming apparatus 10 has a configuration for controlling the timing of starting the operations of the main sheet feeding device 2 depending on an occurrence status of the follow-feeding. In the following, such configuration will be described.

In the image forming apparatus 10, the main sheet feeding device 2 includes a front sheet sensor S1 (see FIG. 2). Furthermore, the conveyance control portion 8b performs the continuous feeding control based on a detection result of the front sheet sensor S1.

The front sheet sensor S1 detects each sheet 9 at a detection position P1 between the pickup roller 21 and the feeding roller 22. FIG. 4 shows a situation in which the front sheet sensor S1 detects a sheet 9 fed across the detection position P1 from the lift plate 11 due to the follow-feeding. The front sheet sensor S1 is an example of a second sheet sensor.

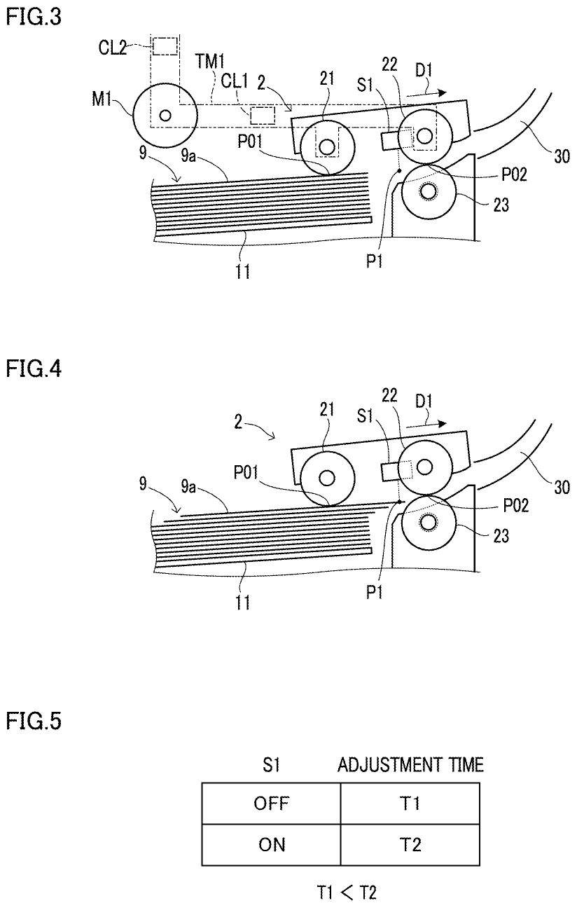

In an example shown in FIG. 3, the front sheet sensor S1 is a reflective photosensor. The front sheet sensor S1 may be a transmissive photosensor or a contact-type object detection sensor.

In FIG. 4, a pickup position P01 is a position of a contact point between the pickup roller 21 and the target sheet 9a. A feeding start point P02 is a position of a contact point between the feeding roller 22 and the separating roller 23.

The detection position P1 is a position between the pickup position P01 and the feeding start point P02. In other words, the detection position P1 is a position on a downstream side in a sheet feeding direction D1 with respect to the pickup position P01, and also a position on an upstream side in the sheet feeding direction D1 with respect to the feeding start point P02. Furthermore, the detection position P1 is a position on the downstream side, in the sheet feeding direction D1, of a leading edge of a sheet 9 appropriately placed on the lift plate 11.

As described above, when the continuous printing process is performed, the conveyance control portion 8b performs the continuous feeding control that repeats the unit feeding control a plurality of times.

In the continuous feeding control, the conveyance control portion 8b performs the first unit feeding control, and then newly starts the unit feeding control at a timing when an adjustment time has elapsed since the resist sheet sensor 32 detected a preceding sheet, every time the resist sheet sensor 32 detects the preceding sheet. In this time, the conveyance control portion 8b sets either one of two predetermined selectable times as the adjustment time, depending on whether or not the resist sheet sensor 32 detects the preceding sheet and then the front sheet sensor S1 detects a subsequent sheet. When the conveyance control portion 8b starts the unit feeding control, it means that the conveyance control portion 8b causes the pickup roller 21 and the feeding roller 22 to start feeding of the subsequent sheet.

Specifically, in the continuous feeding control, upon detection of the preceding sheet by the resist sheet sensor 32, the conveyance control portion 8b sets a first selectable time T1 as the adjustment time when an output of the front sheet sensor S1 is OFF, and sets a second selectable time T2 longer than the first selectable time T1 as the adjustment time when the output of the front sheet sensor S1 is ON (see FIG. 5).

When the output of the front sheet sensor S1 is OFF, it means that the front sheet sensor S1 has not detected a sheet 9. When the output of the front sheet sensor S1 is ON, it means that a sheet 9 is detected by the front sheet sensor S1.

That is, during the continuous printing process, upon detection of a preceding sheet by the resist sheet sensor 32, in a case where a subsequent sheet has been detected by the front sheet sensor S1, the conveyance control portion 8b starts to feed the subsequent sheet later than a case where the subsequent sheet has not been detected.

In other words, when the continuous printing process is performed, the conveyance control portion 8b performs the following controls. The conveyance control portion 8b causes the main sheet feeding device 2 to start feeding of the subsequent sheet when the subsequent sheet is detected by the front sheet sensor S1 at a predetermined first timing after detection of the preceding sheet by the resist sheet sensor 32.

On the other hand, when the subsequent sheet is detected by the front sheet sensor S1 at the first timing, the conveyance control portion 8b causes the main sheet feeding device 2 to start feeding of the subsequent sheet at a second timing later than the first timing.

When the unit feeding control is newly started with the first selectable time T1 as the adjustment time under a state where the leading edge of the target sheet 9a is positioned at the detection position P1, the first selectable time T1 is set to have a minimum interval allowable for each interval of the sheets 9 through the conveyance path 30.

When the unit feeding control is newly started with the second selectable time T2 as the adjustment time under a state where the leading edge of the target sheet 9a is positioned at the feeding start point P02, the second selectable time T2 is set to have a minimum interval allowable for each interval of the sheets 9 through the conveyance path 30.

As above, according to this embodiment, the above-described feeding time interval is adjusted depending on whether or not the follow-feeding in which the leading edge of the target sheet 9a is positioned across the detection position P1 has occurred. This can improve productivity of the printed papers in the continuous printing process.

### A Second Embodiment

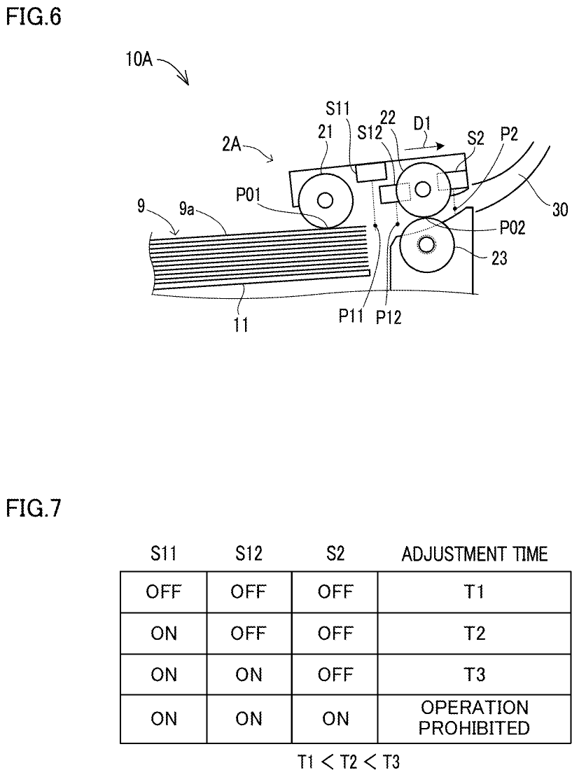

Next, an image forming apparatus 10A according to a second embodiment will be described with reference to FIGS. 6 and 7. The same reference signs are given on components shown in FIG. 6 identical to those shown in FIGS. 3 and 4.

The image forming apparatus 10A has a configuration in which the main sheet feeding device 2 in the image forming apparatus 10 is replaced with a main sheet feeding device 2A. The main sheet feeding device 2A includes two front sheet sensors S11, S12.

The two front sheet sensors S11, S12 are arranged along the sheet feeding direction D1 between the pickup position P01 and the feeding start point P02. Each of the two front sheet sensors S11, S12 detects the corresponding sheet 9 at a respective position P11, P12 different from each other.

The two front sheet sensors S11, S12 are a first front sheet sensor S11 for detecting a sheet 9 at a first detection position P11, and a second front sheet sensor S12 for detecting a sheet 9 at a second detection position P12, respectively. The second detection position P12 is a position on the downstream side, in the sheet feeding direction D1, of the first detection position P11.

The main sheet feeding device 2A further includes a rear sheet sensor S2. The rear sheet sensor S2 detects a sheet 9 at a third detection position P3 on the downstream side in the sheet feeding direction D1 with respect to the feeding roller 22. The rear sheet sensor S2 is an example of a third sheet sensor.

The rear sheet sensor S2 can detect a situation in which the second sheet 9 following the topmost sheet on the lift plate 11 has been fed to the downstream side in the sheet feeding direction D1 with respect to the feeding roller 22 due to the follow-feeding during the unit feeding control.

As shown in FIG. 7, when all the outputs of the two front sheet sensors S11, S12 and the rear sheet sensor S2 are OFF, the conveyance control portion 8b in the image forming apparatus 10A sets the first selectable time T1 as the adjustment time.

When the output of the first front sheet sensor S11 is ON, and when the outputs of the second front sheet sensor S12 and the rear sheet sensor S2 are OFF, the conveyance control portion 8b in the image forming apparatus 10A sets the second selectable time T2 as the adjustment time. The second selectable time T2 is longer than the first selectable time T1.

When the outputs of the first front sheet sensor S11 and the second front sheet sensor S12 are ON, and when the output of the rear sheet sensor S2 is OFF, the conveyance control portion 8b in the image forming apparatus 10A sets a third selectable time T3 as the adjustment time. The third selectable time T3 is longer than the second selectable time T2.

When all the outputs of the two front sheet sensors S11, S12 and the rear sheet sensor S2 are ON, the conveyance control portion 8b in the image forming apparatus 10A prohibits a new execution of the unit feeding control and controls to display an error message on the display 802.

That is, in the continuous feeding control, the conveyance control portion 8b in the image forming apparatus 10A sets a longer adjustment time as a position where the two front sheet sensors S11, S12 respectively detect the sheet 9 on the most downstream side in the sheet feeding direction D1 is closer to the feeding roller 22, under a state where the pickup roller 21 and the feeding roller 22 are stopped. The detection result of the two front sheet sensors S11, S12 represents a leading edge position of the subsequent sheet.

In other words, the conveyance control portion 8b in the image forming apparatus 10A determines the leading edge position of the subsequent sheet depending on the detection result of the two front sheet sensors S11, S12. As the determined position of the leading edge is closer to the feeding roller 22, the start timing in which the unit feeding control is newly performed is delayed. This means that, as the leading edge position is closer to the feeding roller 22, the conveyance control portion 8b controls to further delay the second timing.

The conveyance control portion 8b in the image forming apparatus 10A prohibits a new start of the unit feeding control when a sheet 9 is detected by the rear sheet sensor S2, in the continuous feeding control.

In other words, when the subsequent sheet is detected by the rear sheet sensor S2 at the first timing, the conveyance control portion 8b prohibits that the main sheet feeding device 2A feeds the subsequent sheet.

When the image forming apparatus 10A is adopted, the same effect as when the image forming apparatus 10 is adopted can be obtained. Furthermore, in the image forming apparatus 10A, when the subsequent sheet 9 following the topmost sheet is fed to the downstream side in the sheet feeding direction D1 of the feeding roller 22 in execution of the unit feeding control, the pickup roller 21 and the feeding roller 22 are prohibited from feeding the subsequent sheet.

### A First Modification

In the image forming apparatus 10A, the main sheet feeding device 2 may include three or more front sheet sensors between the pickup position P01 and the feeding start point P02.

### A Second Modification

In the image forming apparatus 10, the continuous feeding control by the conveyance control portion 8b the front sheet sensor S1 may be applied to the auxiliary sheet feeding device 20. In this modification, the manual feed tray 13 is an example of a sheet stacking portion.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a pickup member configured to feed a topmost sheet in a plurality of sheets from a sheet stacking portion, the plurality of sheets being stacked on the sheet stacking portion;
a feeding member configured to feed the sheet fed by the pickup member to a conveyance path;
a feeding portion including the pickup member and the feeding member;
a conveying member that is disposed in the conveyance path, the conveying member configured to convey the sheet fed by the feeding member;
a first sheet sensor that is arranged on an upstream side in a sheet conveyance direction with respect to the conveying member in the conveyance path, the first sheet sensor configured to detect the sheet conveyed along the conveyance path;
at least one second sheet sensor configured to detect the sheet at a position between the pickup member and the feeding member; and
a control portion configured to control the feeding portion when a continuous printing process is performed, wherein
the control portion causes the feeding portion to start feeding of a subsequent sheet when the subsequent sheet is detected by the at least one second sheet sensor at a first timing after detection of a preceding sheet by the first sheet sensor, and
the control portion causes the feeding portion to start feeding of the subsequent sheet at a second timing later than the first timing, when the subsequent sheet is detected by the at least one second sheet sensor at the first timing.

2. The image forming apparatus according to claim 1, wherein
the at least one second sheet sensor includes a plurality of second sheet sensors arranged along in a feeding direction of the sheet, wherein
the control portion delays the second timing more as a leading edge position of a sheet represented by a detection result of the plurality of second sheet sensors is closer to the feeding member.

3. The image forming apparatus according to claim 1, further comprising:
a third sheet sensor configured to detect a sheet at a position on a downstream side in the feeding direction of the sheet with respect to the feeding member, wherein
the control portion prohibits that the feeding portion feeds the subsequent sheet when the subsequent sheet is detected by the third sheet sensor at the first timing.

4. The image forming apparatus according to claim 1, wherein
the pickup member is a pickup roller that is rotated in contact with a surface of a sheet,
the feeding member is a feeding roller that is rotated in contact with the surface of the sheet.

5. The image forming apparatus according to claim 1, wherein
the conveying member is a pair of resist rollers that nips a sheet conveyed in the conveyance path and rotates to convey the sheet at a predetermined timing.
